(19) United States
(12) Patent Application Publication
(10) Pub. No.: US 2009/0261132 A1
(43) Pub. Date: Oct. 22, 2009

(54) SUPERABSORBENT POLYMER APPLICATOR

(75) Inventor: Milan H. Savich, Beaverton, OR (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Absorbent Technologies, Inc., Beaverton, OR (US)

(21) Appl. No.: 12/493,082

(22) Filed: Jun. 26, 2009

Related U.S. Application Data
(63) Continuation of application No. 11/333,129, filed on Jan. 17, 2006.

(51) Int. Cl. B05B 11/04

(52) U.S. Cl. 222/632

(57) ABSTRACT

A superabsorbent polymer (“SAP”) applicator and method for administering a SAP in agricultural applications is disclosed. The SAP applicator may include a dispensing container with a SAP hydrogel disposed therein. The SAP applicator may also optionally include and dispense a growth promoting or other additive.

### CROSS-REFERENCE TO RELATED APPLICATIONS

This patent application is a continuation application of now pending U.S. patent application Ser. No. 11/333,129, filed Jan. 17, 2006 and entitled SUPERABSORBENT POLYMER APPLICATOR, which is incorporated herein by reference.

### TECHNICAL FIELD

The present disclosure relates to superabsorbent polymer products and to methods and articles for applying and delivering superabsorbent polymer products in horticultural and agricultural applications.

### BRIEF DESCRIPTION OF THE DRAWINGS

The embodiments disclosed will become more fully apparent from the following description and appended claims, taken in conjunction with the accompanying drawings. Understanding that these drawings depict only typical embodiments and are, therefore, not to be considered limiting of the scope of the appended claims, the embodiments will be described with additional specificity and detail through use of the accompanying drawings in which:

FIG. 1 is a perspective view of one embodiment of a superabsorbent polymer applicator dispensing a superabsorbent polymer hydrogel; and

FIG. 2 is a side elevation view of one embodiment of a superabsorbent polymer applicator dispensing a superabsorbent polymer hydrogel adjacent the root system of a plant.

### DETAILED DESCRIPTION

Those skilled in the art will recognize that the methods, components and compositions disclosed herein may be arranged and practiced in a wide variety of different configurations, such as without one or more of the specific details described, or with other methods, components, materials, etc. In some cases, well-known materials, components or method steps are not shown or described in detail. Furthermore, the described components, method steps, compositions, etc., may be combined in any suitable manner in one or more embodiments.

Thus, the following more detailed description of various embodiments, as represented in the Figures, is not intended to limit the scope of the present disclosure, but is merely representative of certain exemplary embodiments. While the various aspects of the embodiments are presented in drawings, the drawings are not necessarily drawn to scale unless specifically indicated.

Superabsorbent polymers (“SAPs”) are materials that imbibe or absorb at least 10 times their own weight in aqueous fluid and that retain the imbibed or absorbed aqueous fluid under moderate pressure. The imbibed or absorbed aqueous fluid is taken into the molecular structure of the SAP rather than being contained in pores from which the fluid could be eliminated by squeezing. Some SAPs can absorb up to, or more than, 1,000 times their weight in aqueous fluid.

SAPs may be used in agricultural or horticultural applications. The terms “agricultural” and “horticultural” are used synonymously and interchangeably throughout the present disclosure. Applying SAPs to soil or other plant-growing media in agricultural settings have resulted in earlier seed germination and/or blooming, decreased irrigation requirements, increased propagation, increased crop growth and production, decreased soil crusting, increased yield and decreased time of emergence.

Synthetic SAPs are commercially available and are conventionally used in conjunction with baby or adult diapers, catamenials, hospital bed pads, cable coating and the like. However synthetic SAPs may also be used in agricultural applications. Another type of SAP product used more widely in agricultural applications include starch graft copolymers. Starch graft copolymers comprise a monomer graft polymerized onto a polysaccharide, such as a starch or cellulose. Starch graft copolymers are typically used to absorb aqueous fluids for use in absorbent softgoods, in increasing the water holding capacity of soils, and as coatings onto seeds, fibers, clays, and the like.

One method of producing a starch graft copolymer SAP for use in agricultural applications involves graft polymerizing acrylonitrile onto a starch in the presence of an initiator, such as a ceric (+4) salt, to form the starch graft copolymer, and saponifying the nitrile groups with an alkali metal to form a saponificate having alkali carboxylate and carboxamide groups.

Another method comprises (1) graft polymerizing a monomer, other than acrylonitrile, onto a starch in the presence of an initiator to form a starch graft copolymer; (2) cross-linking the starch graft copolymer, for example, by adding a cross-linking agent; (3) adjusting the pH of the cross-linked starch graft copolymer, e.g., neutralization; (4) isolating the cross-linked starch graft copolymer; and (5) drying the cross-linked starch graft copolymer.

Exemplary polysaccharides include cellulose, starches, flours, and meals. Exemplary starches include native starches (e.g., corn starch (Pure Food Powder, manufactured by A.E. Staley), waxy maize starch (Waxy 7350, manufactured by A.E. Staley), wheat starch (Midsol 50, manufactured by Midwest Grain Products), potato starch (Avebe, manufactured by A.E. Staley)), dextrin starches (e.g., Stadex 9, manufactured by A.E. Staley), dextran starches (e.g., Grade 2P, manufactured by Pharmachem Corp.), corn meal, peeled yucca root, unpeeled yucca root, oat flour, banana flour, and tapioca flour. The starch may be gelatinized to provide optimal absorbency. An exemplary starch is gelatinized cornstarch. Furthermore, according to one embodiment, the weight ratio of the starch to the monomer is in the range of between about 1:1 and about 1:6.

Exemplary initiators for graft polymerizing a monomer onto a starch include cerium (+4) salts, such as ceric ammonium nitrate; ammonium persulfate; sodium persulfate; potassium persulfate; ferrous peroxide; ferrous ammonium sulfate-hydrogen peroxide; L-ascorbic acid; and potassium permanganate-ascorbic acid. Other suitable initiators known to those skilled in the art may be used, such as alternative persulfates and peroxides, as well as vanadium, manganese, etc. The amount of initiator used may vary based on the chosen initiator, the selected monomer, and the chosen starch. Some initiators, e.g., persulfates, may require the presence of heat. The initiator may be added in a single or multiple steps, and multiple initiators may be used.

Exemplary cross-linking agents include: glycerides; diepoxides; diglycidyls; cyclohexadiamide; methylene bis-acrylamide; bis-hydroxyalkylamides, such as bis-hydroxypropyl adipamide; formaldehydes, such as urea-formaldehyde and melamine-formaldehyde resins; isocyanates including di- or tri-isocyanates; epoxy resins, typically in the presence of a base catalyst; and derivatives and mixtures thereof

According to the first exemplary method where acrylonitrile is graft polymerized onto a starch, the resulting starch graft copolymer may be saponified with an alkali metal, such as potassium hydroxide or sodium hydroxide, to convert the nitrile groups into a mixture of carboxamides and alkali carboxylates. The starch graft copolymer may then be precipitated.

In one embodiment, precipitation occurs via an acid titration. Acid, such as hydrochloric acid, nitric acid, sulfuric acid, or phosphoric acid may be added until a pH of between about 2.0 and about 3.5, more particularly about 3.0, is reached. The resulting precipitate may be washed with water to remove the salts, and if necessary, separated in some manner. Separating methods include settling, centrifuging, and other mechanical means of separating.

The carboxylic acid of the starch graft copolymer may then be titrated back to the alkali form with the hydroxide of an alkali metal, such as potassium hydroxide, to a pH of between about 6.0 and about 8.0, more particularly about 7.0. This viscous mass may then be forced through a die plate, dusted to remove tackiness, and air or oven dried. The dried particles are then screened to the appropriate size. If desired, the particles could be ground to fine particles then formed into pellets of the desired size for use in agriculture.

In another embodiment, the isolated product is recovered from the viscous saponificate with the use of water miscible solvents such as alcohols. These include, for example, methanol, ethanol, propanol and isopropanol. The resulting dough is immersed into the alcohol, and the alkali starch graft copolymer is precipitated into particles that are optionally screened after drying to the desired size.

Formation of the starch-containing graft copolymers into particles of the desired size for direct use in agricultural equipment may be achieved by converting the viscous mass of alkali starch-graft copolymers into, for example, rod-shaped forms and drying the forms to the desired particle size. Selecting an appropriate die can vary the rod-shaped forms. A plate may be used that has been drilled or formed to contain holes of a particular size and shape. For example, the diameter of the rods may be controlled by the diameter of the holes drilled in the end plate. In one embodiment, the holes in the end plate may range from between about 1/16 inch to about ¼ inch in diameter. Rod-shaped forms may be lightly coated, after the die, to reduce their tackiness. Clays, starches, flours and cellulose may be used to dust the rods. In another embodiment, the starch graft copolymer may be isolated through the use of an extruder, such as through a heated screw.

According to another method of producing a SAP product, alternative monomers other than acrylonitrile are graft polymerized onto a starch in the presence of an initiator to form a starch graft copolymer. Exemplary alternative monomers include acrylic acid or methacrylic acid. Exemplary monomers may also include acrylamide or methacrylamide. Sulfonic acids, such as 2-acrylamido-2-methyl-propanesulfonic acid (AMPS) and vinyl sulfonic acid may also be used. Moreover, acrylates, such as ethyl acrylate and potassium acrylate may also be used. Derivatives and mixtures of the above-listed monomers may also be desirable.

In applications using acrylic acid, the addition of acrylamide thereto helps induce graft polymerization and adds to absorbency of the SAP. By way of example, the ratio by weight of acrylic acid to acrylamide may be about 2:1. Alternatively, the ratio of acrylic acid to acrylamide may also range up to a ratio of 9:1 and beyond. Because acrylamide is considered a neurotoxin, it may be desirable to reduce the relative amount of acrylamide to acrylic acid, while using enough to help induce graft polymerization of acrylic acid.

In alternative applications, acrylic acid may graft polymerize onto a starch or other polysaccharide without the assistance of acrylamide. For example, acrylic acid may polymerize when placed under heat and/or pressure. Polymerization without the addition of acrylamide may be accomplished, for example, in a heated screw extruder, such as a single screw or a double screw.

As described above, the monomer is graft polymerized onto a polysaccharide in the presence of an initiator to form a starch graft copolymer. Exemplary starches and initiators have been described above. The starch graft copolymer may then be cross-linked, for example, by adding a chemical cross-linking agent to form a cross-linked starch graft copolymer. It may be desirable for the starch graft copolymer to be cross-linked if it dissolves in aqueous fluids previous to being cross-linked. Cross-linking is one method to permit the starch graft copolymer to absorb aqueous fluids without dissolving. However, the amount of cross-linking agent added is typically indirectly proportional to the absorbency of the resulting SAP product. Exemplary cross-linking agents have also been described above.

Alternative methods of cross-linking may also be employed. For example, a solid SAP product may be cross-linked through irradiation, such as through exposure to gamma or x-ray electromagnetic radiation, or to an electron beam and the like. Irradiation facilitates cross-linking of the starch graft copolymer by creating free radicals in the copolymer chain. In some applications, after irradiation an annealing or melting process may be used to re-form the cross-linked copolymer chains. Furthermore, it may be desirable to perform the irradiation process in an atmosphere relatively free of oxygen.

Although the addition of cross-linking agents may be desirable in the production of SAPs, self-cross-linking copolymers may also be used. In a self-cross-linking copolymer, either a single self-reactive functional group or multiple self-reactive functional groups or multiple co-reactive functional groups are incorporated into the mixture. One exemplary co-reactive functional group is a copolymer of acrylic acid and glycidyl methacrylate.

The pH of the cross-linked starch graft copolymer may be adjusted to a desired value for the particular agricultural application. For example, the cross-linked starch graft copolymer may be neutralized to convert the carboxyl groups to potassium salts. Alternative pH values may be desirable depending upon the type of soil and the type of crop the resulting SAPs will be applied to. The resulting pH for most agricultural applications typically will range from about 6.0 to about 8.0. The desired pH may be greater or less than this range depending on the requirements for the particular agricultural application.

Alternatively, in some embodiments, pH adjustment of the starch graft copolymer may occur prior to cross-linking. Exemplary solvents that may be used to effect pH adjustment include potassium hydroxide, potassium methoxide, or a mixture thereof, any of which may optionally be diluted in methanol or other solvents.

In alternative embodiments, pH adjustment may not be necessary. For instance, if potassium acrylate were used as the monomer in lieu of acrylic acid, the resulting product may already be within an acceptable pH range.

The resulting pH-adjusted, cross-linked starch graft copolymer may then be isolated. One exemplary method of isolation involves simply drying the cross-linked starch graft copolymer, such as, for example, on a heated drum or via air-drying. The dried SAP product may then be pelletized according to pelletization methods known to those having skill in the art. According to this embodiment, isolation of the SAP product may be achieved in an alcohol-free environment.

In another embodiment, the step of isolating the starch graft copolymer involves extruding the cross-linked starch graft copolymer such as through a heated screw to form granules of SAP product. To minimize re-agglomeration of the granules, the granules may be coated with a dusting agent that decreases their propensity to stick together. Exemplary dusting agents include cellulose, clay, starch, flour, and other natural or synthetic polymers that prevent the granules from sticking together. Alternatively, the granules may be lightly sprayed with methanol to prevent them from sticking together, and/or the extrusion can be performed under high pressure.

Yet another exemplary method of isolating the starch graft copolymer involves precipitating the pH-adjusted, cross-linked starch graft copolymer using water-miscible solvents such as alcohols, e.g., methanol, ethanol, propanol, and isopropanol. Immersing the cross-linked starch graft copolymer in alcohol may cause the alkali starch graft copolymer to precipitate into particles that are later screened to the desired size after drying. The alcohol removes the water and extraneous salts from the cross-linked starch graft copolymer.

Another exemplary implementation of this method of precipitation involves blending sufficient methanol into the pH-adjusted, cross-linked starch graft copolymer to achieve a smooth dispersion. The smooth dispersion may then be pumped into a precipitation tank, which may include a stirring system that can vigorously mix the methanol while pumping in the smooth cross-linked starch graft copolymer dispersion. Once mixed, the resulting methanol and cross-linked starch graft copolymer particles may be collected by decanting or washing with methanol or centrifuged and collected, then dried to a moisture level of between about 1 percent and about 20 percent.

Another implementation of the isolation step through precipitation with methanol involves wetting the surface of the cross-linked starch graft copolymer with a small amount of methanol and then chopping the cross-linked starch graft copolymer into larger “chunks” that will not re-adhere to one another. Once the surface of the starch graft copolymer has been wetted with methanol, the resulting material is slippery to the touch and is no longer sticky. This effect may be achieved by using a compositional ratio of between about one part and about two parts of methanol per one part of solid.

Once the methanol has been added, the cross-linked starch graft copolymer may be pumped through an in-line chopper to form chunks having a diameter of less than one inch or, alternatively, hand-chopped with scissors. In one embodiment, the resulting mixture is then fed into a tank or Waring blender that has between about 1.5 gallons and about 4.0 gallons of additional methanol per pound of cross-linked starch graft copolymer. In some embodiments, the cross-linked starch graft copolymer may be subject to a pulverizer, in the presence of methanol, such as an in-line mixer or disintegrator which breaks the mass into smaller pieces as desired for the particular application. The methanol in the larger tank may be agitated with a Cowles dissolver or other mixer capable of achieving high speeds.

Yet another implementation of the isolation step through precipitation with methanol involves pre-forming the particle size before the methanol precipitation step. The use of dies to form strands or rods having different shapes and diameters can improve the particle size formation process. This particular implementation offers enhanced control of the final particle size. The cross-linked starch graft copolymer (neutralized or unneutralized) may be forced through a die plate having holes of varying diameter (e.g., about 1/16 inch to more than ¼ inch) and varying shapes (e.g., round, star, ribbon, etc.).

Methods of forcing the cross-linked starch graft copolymer through the die plate include using a hand-operated plunger, screw-feeding, auguring, pumping, and any other commonly known method. The resulting strands or rods may be placed into the precipitation tank without any further addition of methanol as a premixing agent. The strands or rods may be treated to prevent them from sticking together by, for example, wetting or spraying the strands or rods with methanol or dusting them with a dusting agent, such as, for example, cellulose, clay, starch, flour, or other natural or synthetic polymers. The resulting strands or rods may be precipitated with agitated methanol, removed from the tank, and dried.

Alternatively, the cross-linked starch graft copolymer product may be mixed with a solvent, such as water, to form a slurry or gel.

Depending on the agricultural application, the final SAP product may have a particle size that is courser than about 300 mesh. For example, in some applications where the starch graft copolymer is applied directly into the soil with the crop, the particle size is courser than about 50 mesh, such as between about 8 to about 25 mesh. This particle size range correlates to commercially available granule applicators. Therefore, alternative particle sizes may be used.

Finer particle sizes are typically used in seed coating or root dipping applications. By way of example, the particle size for seed coating may be between about 75 and about 300 mesh, such as about 100 mesh. For root coating, the particle size may be between about 30 mesh and about 100 mesh, such as about 50 mesh.

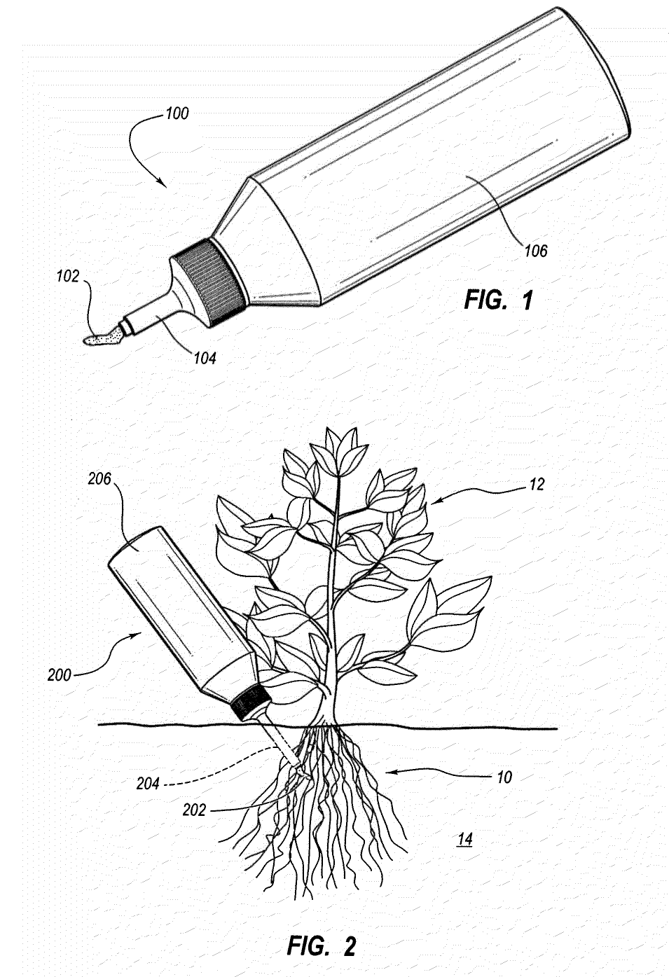

FIG. 1 represents one embodiment of a SAP applicator 100 dispensing a SAP hydrogel 102, as shown from a perspective view. For purposes of this application, the term “hydrogel” as used herein includes among its conventional usage and definition, slurries of various viscosities. The viscosity of the SAP hydrogel 102 may vary as required by the particular SAP applicator 100 and agricultural application. The SAP hydrogel 102 may be produced by dissolving SAP product, such as those described herein, in water or some alternative aqueous fluid to form a hydrogel. According to one embodiment, pelletized SAP particles having a 100 mesh size may be used in forming the SAP hydrogel.

According to the embodiment depicted in FIG. 1, the SAP applicator 100 may be a squeezable plastic dispensing container having an elongate neck portion 104 and a body cavity portion 106 that may contain a majority of the SAP hydrogel 102. In one embodiment, the body cavity portion 104 may be constructed of a flexible plastic material that can be squeezed by a user when it is desirable to dispense the SAP hydrogel 102 contained therein. Upon applying pressure to the body cavity portion 104, the SAP hydrogel 102 exits the applicator 100 upon passing through the elongate neck portion 104.

In this embodiment, the body cavity portion 104 may be considered a squeezable segment. Alternative embodiments may have alternative segments that can be squeezed and/or compressed by a user to deliver the SAP hydrogel 102 disposed within the applicator 100. Exemplary alternative segments may include trigger or button mechanisms, plunger operated mechanisms, or similar mechanisms that would be known to those having skill in the art with the aid of the present disclosure. By having a squeezable segment of the applicator 100, a user need not come into direct contact with the SAP hydrogel 102 while dispensing the same.

The elongate neck portion 104 may optionally be constructed of a plastic material that is more rigid than the flexible body cavity 106 so that the elongate neck portion 104 may penetrate and be inserted into plant-growing media, such as soil. In alternative embodiments the SAP applicator 100 may include a rigid component, that is optionally removable, to penetrate plant-growing media. Upon creating a hole or cavity in the plant-growing media, the rigid component may be removed and SAP hydrogel 102 is subsequently dispensed into the hole or cavity created in the plant-growing media. In yet other alternative embodiments, the SAP applicator 100 may include an alternative dispensing component, such as a pour spout instead of an elongate neck portion 104.

Furthermore, additional embodiments of the SAP applicator 100 are within the scope of the present disclosure. For instance, the SAP applicator may comprise a rigid tube containing SAP hydrogel, the tube optionally having a cone shaped tip for delivering the SAP hydrogel to the particular agricultural application. In such an embodiment, the SAP hydrogel may be discharged using a piston-type caulk gun delivery mechanism. Alternatively a flexible squeeze applicator similar in construction to a toothpaste tube may be used.

Moreover, a syringe-type dispenser may be employed. In some embodiments a single plunger syringe may be used to inject the SAP hydrogel into the desired plant-growth media. In other embodiments, dual or multiple plunger syringes may be used. For example, in a dual plunger syringe applicator, the SAP hydrogel may be disposed within one cylinder of the syringe, while additives, such as fertilizers, herbicides, pesticides, fungicides, growth promoting additives and the like may be disposed within the other cylinder. Upon application, the SAP hydrogel may be mixed before leaving the applicator, or alternatively after exiting the applicator. Furthermore, the additive may be pre-mixed with the SAP hydrogel as would be apparent to those having skill in the art with the aid of the present disclosure.

In other embodiments, the SAP applicator may comprise a canister, similar to a compressed air canister, optionally including a tubular member extending therefrom, such as a straw, for applying the SAP hydrogel. In yet other embodiments, a holding tank coupled to a hose and nozzle, wherein the SAP hydrogel is optionally under pressure, may be used.

Mechanized equipment may further be used as a SAP applicator for larger scale application of SAP hydrogel via mechanical means known to those having skill in the art. Alternative SAP applicators for delivering the SAP hydrogel to a desired plant-growing medium may also be used as would be apparent to those having skill in the art with the aid of the present disclosure.

The SAP applicator 100 may further include indicators of dosing amounts of SAP hydrogel 102 that may be delivered to plant-growing media. For example, the indicators may comprise lines disposed on the body cavity portion 106 of the applicator 100 to indicate a volume of SAP hydrogel 102 to be delivered per plant or per a number of plants.

The SAP applicator 100 may include additional additives premixed with, or configured to be delivered with the SAP hydrogel 102. For example, various fertilizers that are commercially available may be included as would be apparent to those having skill in the art. In some embodiments, controlled-release fertilizers may be used. Alternative or additional additives that may also be included within the SAP applicator 100 may include pesticides, herbicides, fungicides, growth hormones and regulators, mycorrhizal fungi, kelp products, soil-based nutrients and the like.

Exemplary pesticides that may be included in the SAP applicator 100 include, but are not limited to, acaricides, algicides, antifeedants, avicides, bactericides, bird repellents, chemosterilants, herbicide safeners, insect attractants, insect repellents, insecticides, mammal repellents, mating disruptors, molluscicides, nematicides, plant activators, plant-growth regulators, rodenticides, synergists, and virucides. Exemplary microbial pesticides include bacillus thuringiensis and mycorrhizal fungi. Exemplary insecticides include, but are not limited to, thiodan, diazinon, and malathion.

Exemplary commercially available pesticides include, but are not limited to: Admire™ (imidacloprid) manufactured by Bayer, Regent™ (fipronil) manufactured by BASF, Dursban™ (chlorpyrifos) manufactured by Dow, Cruiser™ (thiamethoxam) manufactured by Syngenta, Karate™ (lambda-cyhalothrin) manufactured by Syngenta, and Decis™ (deltamethrin) manufactured by Bayer. A combination or blend of pesticides may also be used. Alternative pesticides may also be used as would be apparent to those having skill in the art.

Fungicides may also be included in the SAP applicator 100. Fungicides may help control or prevent the growth of mold or fungus on the roots, seeds or seedlings thus inhibiting root or seed rot. Exemplary commercially available fungicides include, but are not limited to: Amistar™ (azoxystrobin) manufactured by Syngenta, Folicur™ (tebuconazole) manufactured by Bayer, Opus™ (epoxiconazole) manufactured by BASF, Dithane™ (mancozeb) manufactured by Dow, Flint™ (trifloxystrobin) manufactured by Bayer, and Ridomil™ (metalaxyl) manufactured by Syngenta. A combination or blend of fungicides may also be used. Alternative fungicides may also be used as would be apparent to those having skill in the art.

Regarding pesticides and fungicides, starch-based polymer SAP encapsulated pesticides or fungicides may imbibe water and swell such that the pesticide particles diffuse out of the starch matrix into the soil surrounding a plant, root, seed, or seedling in a controlled manner. Two exemplary goals of controlled-release pesticides or fungicides are (1) to increase efficacy of the pesticide/fungicide and (2) to reduce negative environmental consequences of pesticide/fungicide application.

Exemplary commercially available herbicides that may be included in the SAP applicator 100 include, but are not limited to: Roundup™ (glyphosate) manufactured by Monsanto, Gramoxone™ (paraquat) manufactured by Syngenta, Harness™ (acetochlor) manufactured by Monsanto, Prowl™ (pendimethalin) manufactured by BASF, Dual™ (metolachlor) manufactured by Syngenta, and Puma™ (fenoxaprop) manufactured by Bayer. Furthermore, a combination or blend of herbicides may be used. Alternative herbicides may also be used as would be apparent to those having skill in the art.

Exemplary commercially available plant-growth regulators that may be optionally included in the SAP applicator 100 include, but are not limited to: Ethrel™ (ethephon) manufactured by Bayer, Pix™ (mepiquat) manufactured by BASF, Dropp™ (thidiazuron) manufactured by Bayer, Finish™ (cyclanilide) manufactured by Bayer, and Royal MH™ (maleic hydrazide) manufactured by Crompton. A combination or blend of growth regulators may be used. Furthermore, growth inhibitors, growth retardants, growth stimulants, and derivatives and mixtures thereof may be included. Alternative growth regulators or hormones may also be used as would be apparent to those having skill in the art.

Exemplary soil-based nutrients that may be optionally included in the SAP applicator 100 include calcium, magnesium, potassium, phosphorus, boron, zinc, manganese, copper, iron, sulfur, nitrogen, molybdenum, silicon, ammonium phosphate, fish meal, organic compounds and additives, organic based fertilizers derived from plant and animal products, and derivatives, blends, and mixtures thereof. More information about exemplary growth-promoting additives can be found in The Farm Chemicals Handbook published by Meister Publishing Company.

The SAP hydrogel 102 promotes growth of the seed, seedling or plant where the SAP hydrogel 102 is applied, as well as a more efficient uptake of nutrients, etc. Plant growth is facilitated by promoting the availability of beneficial nutrients to the plant, root, seed, or seedling. The high absorptivity of the SAP hydrogel 102 facilitates entrapment of fertilizers and other additives heretofore described, thereby minimizing or eliminating disassociation or release of the additive from the SAP matrix due to heavy rainfall, watering, etc. Because some amount of the additive will become entrapped in the matrix of the SAP hydrogel 102, the runoff rate of additives is significantly reduced.

FIG. 2 represents one embodiment of a SAP applicator 200 dispensing a SAP hydrogel 202 adjacent a root system 10 of a plant 12. According to one exemplary method of delivering a SAP in agricultural applications, a SAP applicator 200 as heretofore described is obtained. The SAP applicator 200 may include an elongate neck portion 204 that may be inserted into plant-growing media, such as soil 14. The neck portion 204 may vary in length depending upon the particular agricultural application. The neck portion 204 may be inserted adjacent the actual root system 10 of a plant, or in the context of a seed, seedling, or before planting, the anticipated location of the root system.

According to one embodiment, after the neck portion 204 is inserted into the plant-growing media 14, the body cavity portion 206 may be squeezed by the user to dispense the SAP hydrogel 202. Alternative mechanisms and methods for dispensing the SAP hydrogel 202 may be used as heretofore described, and as would be apparent to those having skill in the art with the aid of the present disclosure.

According to the embodiment depicted in FIG. 2, the body cavity portion 206 is maintained outside of the plant-growing media 14 while the SAP hydrogel 202 is being dispensed. Consequently, a user does not have to handle the SAP hydrogel 202, and there is relatively little if any clean up required. According to some embodiments, the SAP hydrogel 202 may be applied to the soil after, instead of traditionally before planting.

Application of the SAP hydrogel 202 in proximity to a root system 10 of a plant, seed or seedling promotes the availability of beneficial nutrients and/or water to the plant 12, seed or seedling. Increasing the availability of nutrients and/or water may affect an increase in crop yield, growth rate, seed germination, and/or plant size, and may affect earlier seed germination and/or blooming, decreased irrigation requirements, increased propagation, increased crop growth, increased crop production, decreased soil crusting, increased root development, stronger/heartier plants, and plants less susceptible to disease.

Moreover, the use of the SAP applicators 100, 200 described herein reduce the human exposure to chemicals, the SAP hydrogel 202, the additives, etc. The efficiency and accuracy of applying the SAP hydrogel 202 and additives may be improved because the SAP hydrogel 202 is dispensed and maintained at the desired location adjacent the root system 10. The SAP applicator 200 may also reduce the loss of SAP product and additive to the air (in the form of dust) that occurs in conventional, dry applications. Moreover, the application of SAP hydrogel may also provide for a reduction in groundwater contamination, toxicity, odor, volatility, and decompositional problems compared to the application of fertilizers not entrapped in an SAP matrix.

While specific embodiments and applications have been illustrated and described, it is to be understood that the present disclosure is not limited to the precise configuration and components disclosed herein. Various modifications, changes, and variations which will be apparent to those skilled in the art may be made in the arrangement, operation, and details of the components, compositions and methods disclosed herein without departing from the spirit and scope of the following claims.

What is claimed is:

1. A superabsorbent polymer applicator for administering a superabsorbent polymer in agricultural applications, comprising:
a dispensing container; and
a superabsorbent polymer hydrogel disposed within the dispensing container;
wherein the dispensing container is configured to deliver the superabsorbent polymer hydrogel locally to a desired agricultural application when initiated by a user.

2. The superabsorbent polymer applicator of claim 1, wherein the dispensing container is configured to deliver the superabsorbent hydrogel adjacent an actual or anticipated location of a root system of a plant, plant cutting, seed or seedling.

3. The superabsorbent polymer applicator of claim 1, wherein the dispensing container includes an elongate neck portion through which the superabsorbent polymer hydrogel passes when delivered to the desired agricultural application.

4. The superabsorbent polymer applicator of claim 3, wherein the elongate neck portion is configured to be inserted into media adjacent an actual or anticipated location of a plant root system while a body cavity portion of the dispensing container remains outside of the media.

5. The superabsorbent polymer applicator of claim 1, wherein the dispensing container delivers superabsorbent polymer hydrogel when a segment of the dispensing container is squeezed by the user.

6. The superabsorbent polymer applicator of claim 5, wherein the dispensing container is constructed of a flexible plastic material.

7. The superabsorbent polymer applicator of claim 1, wherein the dispensing container includes indicators of dosing amounts of the superabsorbent polymer hydrogel disposed therein.

8. The superabsorbent polymer applicator of claim 1, further comprising at least one of the following: fertilizers, herbicides, pesticides, fungicides and growth regulators disposed within the dispensing container.

9. The superabsorbent polymer applicator of claim 1, wherein the superabsorbent polymer hydrogel comprises acrylonitrile monomers.

10. The superabsorbent polymer applicator of claim 1, wherein the superabsorbent polymer hydrogel comprises monomers that are at least one of the following: acrylic acid, acrylamide, methacrylamide, 2-acrylamido-2-methyl-propanesulfonic acid, methacrylic acid, vinyl sulfonic acid, ethyl acrylate, potassium acrylate, and derivatives and mixtures thereof.

11. A superabsorbent polymer applicator for administering a superabsorbent polymer in agricultural applications, comprising:
a dispensing container having an elongate neck portion; and
a superabsorbent polymer hydrogel disposed within the dispensing container;
wherein the superabsorbent polymer hydrogel passes through the elongate neck portion when the superabsorbent hydrogel is delivered to a particular agricultural application.

12. The superabsorbent polymer applicator of claim 11, wherein the elongate neck portion is configured to be inserted into planting media adjacent an actual or anticipated location of a plant root system while a body cavity portion of the dispensing container containing a majority of the superabsorbent polymer hydrogel remains outside of the planting media.

13. The superabsorbent polymer applicator of claim 11, wherein the dispensing container is configured to deliver the superabsorbent polymer hydrogel when a segment of the dispensing container is squeezed by a user.

14. The superabsorbent polymer applicator of claim 11, further comprising at least one of the following: fertilizers, herbicides, pesticides, fungicides and growth regulators disposed within the dispensing container.

15. The superabsorbent polymer applicator of claim 11, wherein the superabsorbent polymer hydrogel comprises monomers that are at least one of the following: acrylonitrile, acrylic acid, acrylamide, methacrylamide, 2-acrylamido-2-methyl-propanesulfonic acid, methacrylic acid, vinyl sulfonic acid, ethyl acrylate, potassium acrylate, and derivatives and mixtures thereof.

16. A method for delivering a superabsorbent polymer in agricultural applications, comprising:
obtaining a superabsorbent polymer hydrogel disposed within a dispensing container, the container having an insertable portion to insert into plant-growing media;
inserting the insertable portion of the dispensing container into the plant-growing media; and
dispensing the superabsorbent polymer hydrogel into the plant-growing media through the insertable portion.

17. The method of claim 16, wherein dispensing the superabsorbent polymer hydrogel further comprises squeezing a segment of the dispensing container to dispense the superabsorbent polymer hydrogel.

18. The method of claim 16, wherein inserting the insertable portion of the dispensing container further comprises maintaining a body cavity of the dispensing container outside of the plant-growing media, the body cavity containing a majority of the superabsorbent polymer hydrogel.

19. The method of claim 16, further comprising dispensing additives into the plant-growing media concurrently with dispensing the superabsorbent polymer hydrogel, wherein the additives are at least one of the following: fertilizers, herbicides, pesticides, fungicides and growth regulators.
